(19) United States
(12) Patent Application Publication
(10) Pub. No.: US 2024/0068297 A1
(43) Pub. Date: Feb. 29, 2024

(54) PEAK COVER FOR LIFT CORD AND TILT LADDER

(71) Applicants: Mason Chou, Irvine, CA (US); Tser Wen CHOU, Yorba Linda, CA (US)

(72) Inventor: Tser Wen CHOU, Yorba Linda, CA (US)

(21) Appl. No.: 17/899,371

(22) Filed: Aug. 30, 2022

(51) Int. Cl. E06B 9/306; E06B 9/327

(52) U.S. Cl. CPC E06B 9/306; E06B 9/327

(57) ABSTRACT

A peak cover for lift cord and tilt ladder includes a limiter having an arcuate cover. A fixed engagement plate is disposed at an upper end of a left side of the arcuate cover. Two stop walls are disposed on two sides of a lower end of the left side of the arcuate cover. Two grooves are formed inside the stop walls. Two annular ribs of a cord winding reel are engaged in the grooves, whereby the cord winding reel is freely rotatable. A movable engagement plate is disposed at an upper end of a right side of the arcuate cover. Four raised columns are formed on an upper end of the arcuate cover. The arcuate cover of the limiter is capped on the cord winding reel. The fixed engagement plate and the movable engagement plate of the arcuate cover are engaged with the annular ribs on two sides of the cord winding reel. Accordingly, after the arcuate cover is connected with the cord winding reel, the arcuate cover blocks the space above the cord winding reel so as to prevent the cord wound on the cord winding reel from jumping out of the cord winding reel.

### BACKGROUND OF THE INVENTION

### 1. Field of the Invention

The present invention relates generally to a peak cover for lift cord and tilt ladder, and more particularly to a limiter, which can prevent the cord from jumping out of the cord winding reel and locate the ladder and make the blind more smoothly operated.

### 2. Description of the Related Art

In a conventional blind, the ladder is secured to a rotational polygonal drum. The rotational polygonal drum is rotated to tilt the ladder so as to control opening/closing of the blind slats. In addition, a bead chain controller is used to drive a rotational shaft. More than two cord winding reels are disposed on the rotational shaft. A pull cord is wound on the cord winding reels. The pull cord is passed through the blind slats to connect with a bottom bar. The bead chain controller serves to drive the rotational shaft and the cord winding reels to synchronously rotate so as to control ascending/descending of the blind slats. When the cord winding reels operate the blind slats to move up and down, the blind slats will be stacked. At this time, the cord wound on the cord winding reels is not tensioned by gravity and is loosened. In this case, the cord is apt to jump out of the cord winding reels. As a result, the blind slats will be deflected and unbalanced so that the cord winding reels cannot be further operated. The rotational polygonal drum of the blind is used to control the opening/closing of the blind slats. When the blind slats swing and displace, the ladder swings and displaces along with the blind slats. There is no stop structure for the rotational polygonal drum to which the ladder is secured. Therefore, the ladder is apt to jump out of the rotational polygonal drum to affect the operation of the ladder.

### SUMMARY OF THE INVENTION

It is therefore a primary object of the present invention to provide a limiter, which can effectively prevent the blind lift cord from jumping out of the cord winding reel and effectively enhances the stability of operation of a horizontal blind. The limiter is mounted between the rotational polygonal drum and the cord winding reel and connected with the cord winding reel. When the lift cord of the horizontal blind is pulled to control the ascending/descending of the blind slats, the arcuate cover of the limiter blocks the space above the cord winding reel so as to prevent the loosened cord from jumping out of the cord winding reel when wound on the cord winding reel. Accordingly, the lift cord can be smoothly wound on the cord winding reel to enhance the smoothness and balance of the operation of the horizontal blind. When the cord winding reel is rotated to bounce up and down, the four raised columns of the upper end of the arcuate cover stop the two lateral sides of the rotational polygonal drum. Therefore, the limiter can locate and balance the cord winding reel. In addition, the ladder of the rotational polygonal drum can downward suspend along the gap between the four raised columns of the arcuate cover. Therefore, the ladder is prevented from jumping out of the rotational polygonal drum along with the swing and deflection of the blind slats.

To achieve the above and other objectives, the peak cover for lift cord and tilt ladder of the present invention includes a limiter having an arcuate cover. A fixed engagement plate is disposed at an upper end of a left side of the arcuate cover. Two stop walls are disposed on two sides of a lower end of the left side of the arcuate cover. Two grooves are formed inside the stop walls. Two annular ribs of a cord winding reel are engaged in the grooves, whereby the cord winding reel is freely rotatable. A movable engagement plate is disposed at an upper end of a right side of the arcuate cover. Four raised columns are formed on an upper end of the arcuate cover. The four raised columns are respectively disposed on four corners of the arcuate cover. Four slopes are formed on inner sides of the four raised columns. The limiter is disposed between a cord winding reel and a rotational polygonal drum. The movable engagement plate and the fixed engagement plate of the arcuate cover are engaged with outer sides of two annular ribs of the cord winding reel, whereby the arcuate cover is connected with the cord winding reel and the cord winding reel can be still rotated to wind/unwind the cord. The arcuate cover blocks the space above the cord winding reel, whereby the arcuate cover can stop the loosened cord wound on the cord winding reel from jumping out of the cord winding reel. When the cord winding reel is rotated and bounces, the arcuated cover limits the cord winding reel's bouncing. At this time, the four raised columns of the arcuate cover stop the lateral sides of the rotational polygonal drum, whereby the limiter can locate and balance the cord winding reel. In addition, the ladder of the rotational polygonal drum can downward suspend along the gap between the four raised columns of the arcuate cover. Therefore, the ladder is prevented from jumping out of the rotational polygonal drum along with the swing and deflection of the blind slats.

With respect to the technical principle of the present invention, the limiter has an arcuate cover and four raised columns formed on the arcuate cover. The limiter is disposed between the cord winding reel and the rotational polygonal drum. The arcuate cover controls the space above the cord winding reel with the four raised columns to control the rotational polygonal drum. When operating the blind slats to move up and down, the arcuate cover can stop the loosened cord wound on the cord winding reel from jumping out of the cord winding reel. When the cord winding reel is rotated and bounces, the arcuated cover limits the cord winding reel's bounce. At this time, the four raised columns at the upper end of the arcuate cover stop the lateral sides of the rotational polygonal drum, whereby the limiter can locate and balance the cord winding reel without swinging and deflecting.

In addition, the ladder of the rotational polygonal drum can downward suspend along the gap between the four raised columns of the arcuate cover. Therefore, the ladder is prevented from jumping out of the rotational polygonal drum along with the swing and deflection of the blind slats.

The present invention can be best understood through the following description and accompanying drawings, wherein:

### BRIEF DESCRIPTION OF THE DRAWINGS

FIG. 1 is a left perspective view of the limiter of the present invention;

FIG. 2 is a bottom perspective view of the limiter of the present invention;

FIG. 3 is a right perspective view of the limiter of the present invention;

FIG. 4 is a perspective exploded view of the present invention;

FIG. 5 is a perspective assembled view of the present invention;

FIG. 6 is a side view showing the installation of the present invention;

FIG. 7 is a perspective exploded view of the present invention, showing the application of the present invention to a horizontal blind;

FIG. 8 is a perspective assembled view of the present invention, showing the application of the present invention to the horizontal blind;

FIG. 9 is a perspective view of the present invention, showing the application of the present invention to the horizontal blind; and

FIG. 10 is a side view of the present invention, showing the application of the present invention to the horizontal blind.

### DETAILED DESCRIPTION OF THE PREFERRED EMBODIMENTS

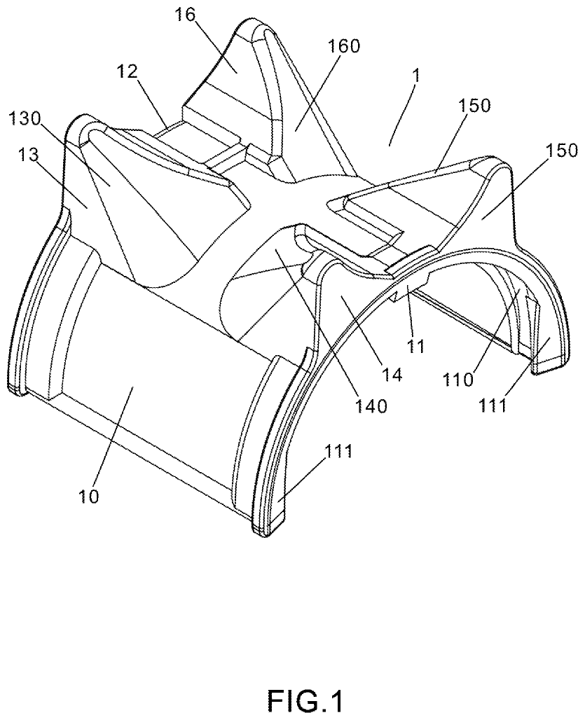

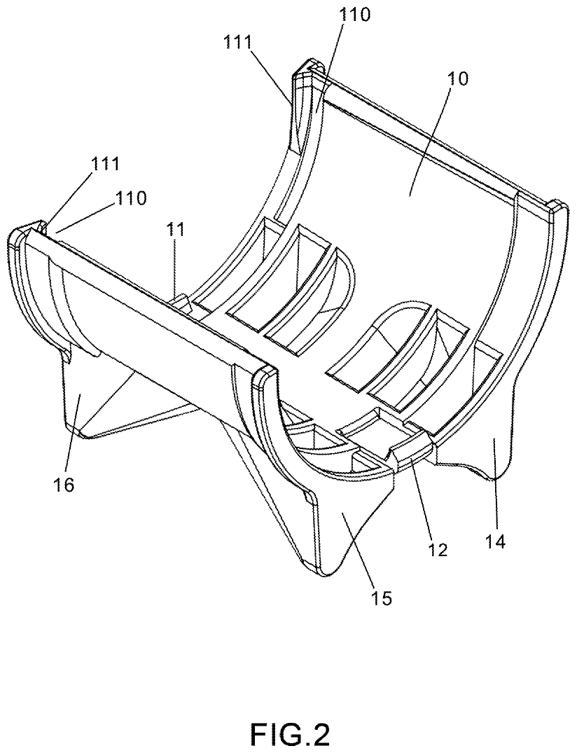

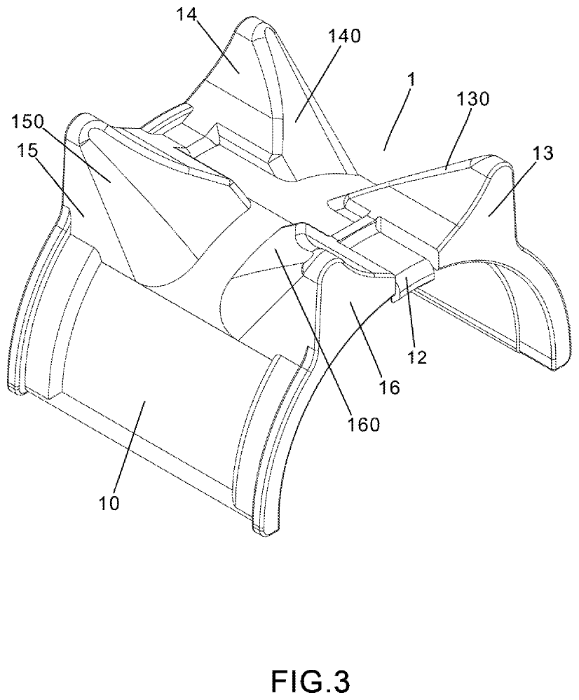

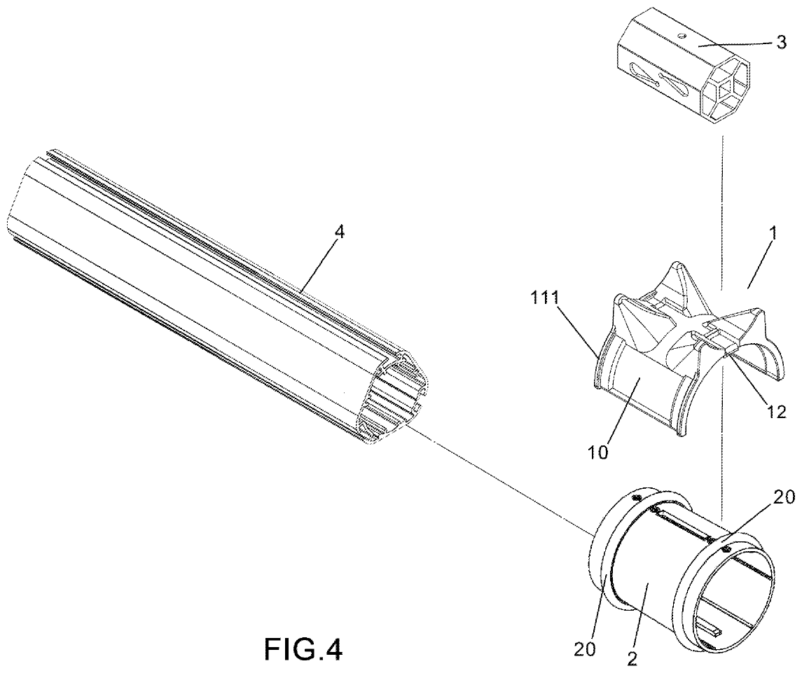

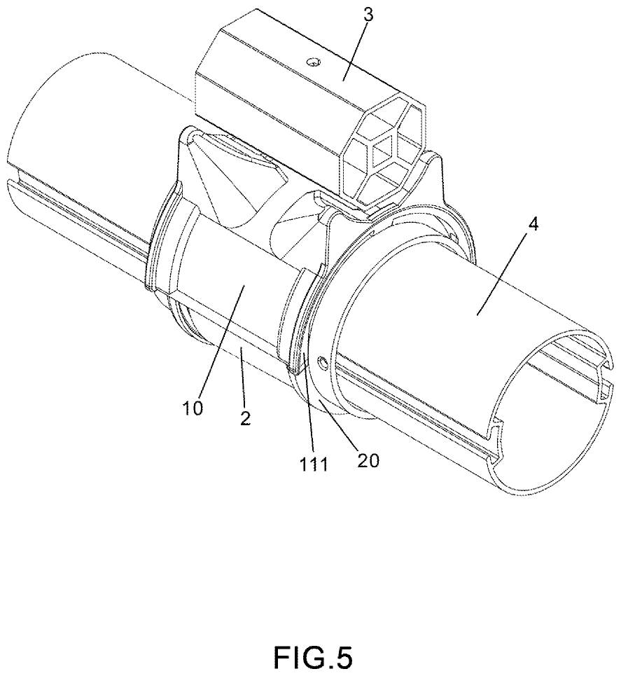

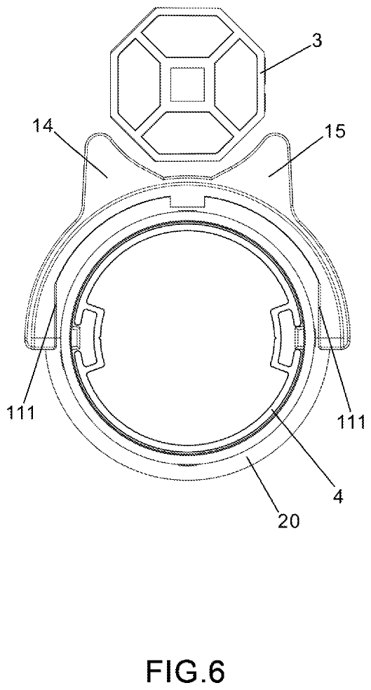

Please refer to FIGS. 1, 2 and 3. An arcuate cover 10 is disposed at a lower end of the limiter 1 of the present invention. More than one fixed engagement plate 11 is disposed at an upper end of a left side of the arcuate cover 10. In addition, two stop walls 111 are disposed on two sides of a lower end of the left side of the arcuate cover 10. Two grooves 110 are formed inside the stop walls 111. A movable engagement plate 12 is disposed at an upper end of a right side of the arcuate cover 10. In addition, four raised columns 13, 14, 15, 16 are formed on the upper end of the arcuate cover 10. Four slopes 130, 140, 150, 160 are formed on inner sides of the four raised columns 13, 14, 15, 16. The arcuate cover 10 of the limiter 1 is capped on a cord winding reel 2 and positioned under a rotational polygonal drum 3. The fixed engagement plate 11 and the movable engagement plate 12 of the arcuate cover 10 are engaged with two annular ribs 20 on two sides of the cord winding reel 2 fitted on a top tube 4. The annular ribs 20 of the cord winding reel 2 are engaged in the grooves 110 of the stop walls 111, whereby the cord winding reel 2 can be freely rotated. Accordingly, after the arcuate cover 10 is connected with the cord winding reel 2, the cord winding reel 2 can be still rotated to wind/unwind the cord (as shown in FIGS. 4, 5 and 6).

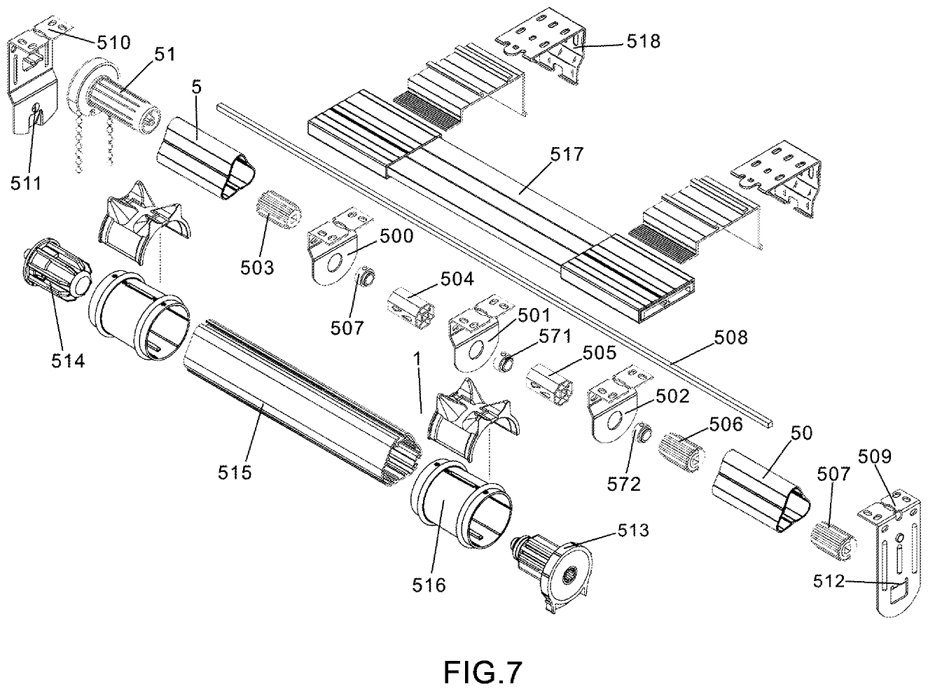

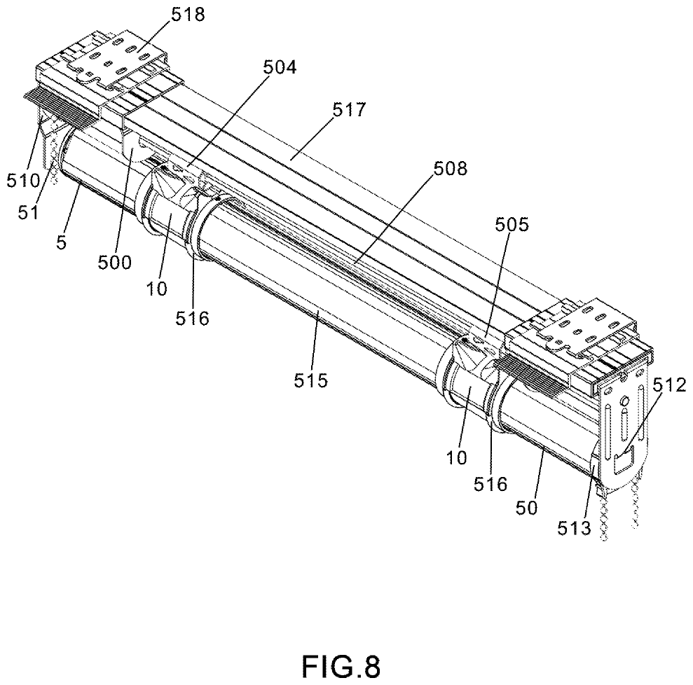

Please refer to FIGS. 7, 8 and 9, which show the application of the limiter of the present invention to a horizontal blind. Three locating support brackets 500, 501, 502 are disposed between two triangular tubes 5, 50. Each of the three locating support brackets 500, 501, 502 is connected with a rotational shaft retaining seat 570, 571, 572. A connection body 503 is disposed between the locating support bracket 500 and the triangular tube 5. A rotational polygonal drum 504 and a rotational polygonal drum 505 are respectively disposed between the locating support brackets 500, 501, 502. In addition, connection bodies 506, 507 are respectively disposed on two sides of the triangular tubes 5, 50. Each of the rotational polygonal drums 504, 505 and the connection bodies 506, 507 is formed with a central quadrangular hole fora rotational shaft 508 to pass through. The rotational shaft 508 is passed through the connection body 503, the rotational shaft retaining seats 570, 571, 572 and the rotational polygonal drums 504, 505. Two ends of the rotational shaft 508 are respectively located on a securing bracket 509 and a securing bracket 510. A bead chain controller 51 is fitted in the triangular tube 5 to control rotation of the triangular tube 5. The bead chain controller 51 is secured on the securing bracket 510. A tube plug shaft hole 511 and an insertion plate 512 are additionally disposed at lower ends of the two securing brackets 509, 510. A bead chain controller 513 is securely disposed on the insertion plate 512. A tube plug 514 is securely disposed in the tube plug shaft hole 511. The bead chain controller 513 and the tube plug 514 serve to locate a triangular top tube 515. Two cord winding reels 516 are additionally fitted on the triangular top tube 515. A limiter 1 is capped on the upper end of the cord winding reel 516 corresponding to the rotational polygonal drums 504, 505. The above components are assembled to complete the horizontal bind structure. The horizontal blind is then secured above a window by means of a rail support bracket 517 and securing leaf spring brackets 518. The bead chain controller provides driving force to make the triangular tube 5 rotate. At the same time, the connection bodies in the triangular tube and the rotational polygonal drums 504, 505 on the rotational shaft 508 are synchronously rotated. Through the rotational shaft 508, the other triangular tube 50 is synchronously rotated so as to achieve a uniform and synchronous driving effect.

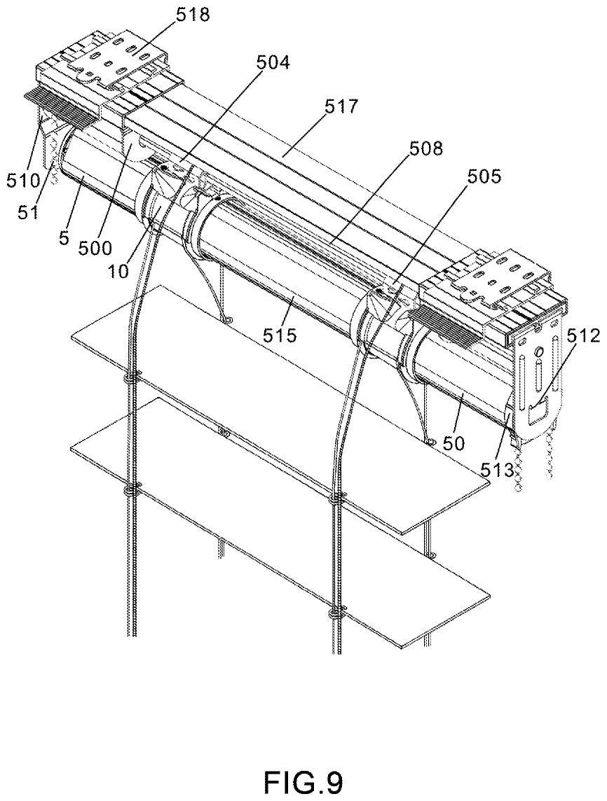

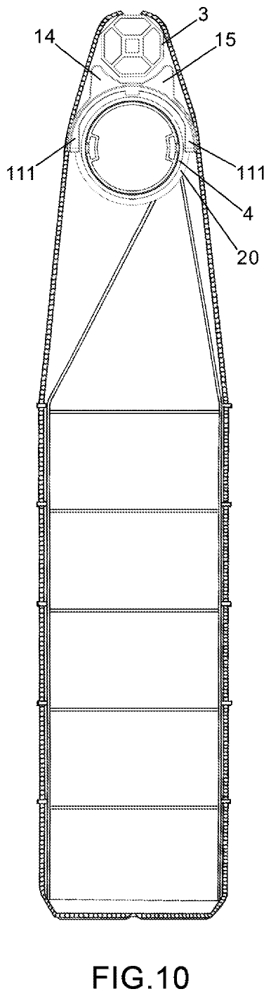

Please now refer to FIGS. 9 and 10. With respect to the operation theory of the present invention, the arcuate cover 10 of the limiter 1 is capped on the cord winding reel 2 and positioned under the rotational polygonal drum 3. The fixed engagement plate 11 and the movable engagement plate 12 of the arcuate cover 10 are engaged with the annular ribs 20 on two sides of the cord winding reel 2. After the arcuate cover 10 is connected with the cord winding reel 2, the arcuate cover 10 blocks the space above the cord winding reel 2 so as to prevent the cord wound on the cord winding reel 2 from jumping out of the cord winding reel 2. When the cord winding reel 2 is rotated and bounces up and down, the four raised columns 13, 14, 15, 16 of the upper end of the arcuate cover 10 stop the lateral sides of the rotational polygonal drum 3 (as shown in FIG. 10). Therefore, the limiter 1 can locate and balance the cord winding reel 3. In addition, the ladder of the rotational polygonal drum 3 can downward suspend along the gap between the four raised columns 13, 14, 15, 16 of the arcuate cover 10 to be smoothly wound on the rotational polygonal drum 3.

The above embodiments are only used to illustrate the present invention, not intended to limit the scope thereof. Many modifications of the above embodiments can be made without departing from the spirit of the present invention.

What is claimed is:

1. A peak cover for lift cord and tilt ladder, comprising a limiter having an arcuate cover, the arcuate cover having two openings passing through the arcuate cover in communication with each other, four raised columns being formed on an upper end of the arcuate cover, the four raised columns being respectively disposed on four corners of the upper end of the arcuate cover, the limiter being disposed between a cord winding reel and a rotational polygonal drum of a blind, when operating blind slats to move up and down, the cord wound on the body of the cord winding reel becoming loosened, the loosened cord being stopped by the arcuate cover from jumping out of the cord winding reel, whereby when the cord winding reel bounces, the four raised columns of the upper end of the arcuate cover stopping lateral sides of the rotational polygonal drum, whereby the limiter can locate and balance the cord winding reel and a ladder of the rotational polygonal drum can downward suspend along the gap between the four raised columns of the arcuate cover to be smoothly wound on the rotational polygonal drum.

2. The peak cover for lift cord and tilt ladder as claimed in claim 1, wherein four slopes are formed on inner sides of the four raised columns.

3. The peak cover for lift cord and tilt ladder as claimed in claim 1, wherein a fixed engagement plate is disposed at an upper end of a left side of the arcuate cover, the fixed engagement plate being engaged with an outer side of an annular rib of the cord winding reel with the cord winding reel freely rotatable.

4. The peak cover for lift cord and tilt ladder as claimed in claim 1, wherein a movable engagement plate is disposed at an upper end of a right side of the arcuate cover, the movable engagement plate being engaged with an outer side of an annular rib of the cord winding reel with the cord winding reel freely rotatable.

5. The peak cover for lift cord and tilt ladder as claimed in claim 1, wherein two stop walls are disposed on two sides of a lower end of the left side of the arcuate cover, two grooves being formed inside the stop walls, the annular ribs of the cord winding reel being engaged in the grooves of the stop walls, whereby the cord winding reel is freely rotatable.

6. The peak cover for lift cord and tilt ladder as claimed in claim 1, wherein arcuate faces are formed between the raised columns and the ladder on the rotational polygonal drum downward suspends along arcuate faces.
